(19) United States
(12) Patent Application Publication
(10) Pub. No.: US 2024/0097336 A1
(43) Pub. Date: Mar. 21, 2024

(54) ANTENNA DEVICE AND ANTENNA MODULE

(71) Applicant: MEDIATEK Inc., Hsinchu City (TW)

(72) Inventor: Chung-Hsin CHIANG, Hsinchu City (TW)

(21) Appl. No.: 18/462,564

(22) Filed: Sep. 7, 2023

Related U.S. Application Data
(60) Provisional application No. 63/375,881, filed on Sep. 16, 2022.

(51) Int. Cl. H01Q 9/04; H01Q 1/38; H01Q 1/48

(52) U.S. Cl. CPC H01Q 9/0407; H01Q 1/38; H01Q 1/48

(57) ABSTRACT

An antenna device is provided, which includes a ground plate, a patterned radiating layer and a wall structure. The patterned radiating layer is arranged above the ground plate. The wall structure is formed above the ground plate. On a first reference plane substantially parallel with the ground plate, a projection of the wall structure overlaps a projection of the patterned radiating layer. With respect to a first reference axis substantially perpendicular to the ground plate, an upper surface of the wall structure is lower than the patterned radiating layer.

This application claims the benefit of U.S. provisional application Ser. No. 63/375,881, filed Sep. 16, 2022, the entirety of which is incorporated herein by reference.

### TECHNICAL FIELD

The present disclosure is related to an operation device in a communication apparatus, and more particularly, related to an antenna device in the communication apparatus.

### BACKGROUND

In a communication apparatus, a front end serves to transmit and receive radio frequency (RF) signals. Furthermore, in the front end of the communication apparatus, an antenna device is relied on to providing antenna gain and directivity for the RF signals.

In order to achieve a greater antenna gain and a better signal quality, the antenna device may be provided with a cavity. The cavity may be formed between the radiating plates and ground plate of the antenna device. However, a large-sized cavity for the antenna device may significantly increase the size of the antenna module including the antenna device, which may hence deteriorate compactness of the communication apparatus.

In view of the above issues, it is desirable to have an antenna device with an improved structure, in which a small-sized cavity can be achieved.

### SUMMARY

According to an aspect of the present disclosure, an antenna device is provided. The antenna device includes the following elements. A ground plate. A patterned radiating layer, which is arranged above the ground plate. A wall structure, which is formed above the ground plate. On a first reference plane substantially parallel with the ground plate, a projection of the wall structure overlaps a projection of the patterned radiating layer, and, with respect to a first reference axis substantially perpendicular to the ground plate, an upper surface of the wall structure is lower than the patterned radiating layer.

According to another aspect of the present disclosure, an antenna module is provided. The antenna module includes a plurality of antenna devices. The wall structure of one of the antenna devices is connected with the wall structure of an adjacent one of the antenna devices, and the wall structures of all of the antenna devices form a main cavity which substantially surrounds the projections of the patterned radiating layers of all of the antenna devices.

### BRIEF DESCRIPTION OF THE DRAWINGS

FIG. 1A is a perspective view of an antenna device 1001 according to an embodiment of the present disclosure.

FIG. 1B is a side view of the antenna device 1001 of FIG. 1A.

FIG. 1C is a top view of the antenna device 1001 of FIG. 1A.

FIG. 2 is a perspective view of an antenna device 1002 according to another embodiment of the present disclosure.

FIG. 3 is a perspective view of an antenna device 1003 according to still another embodiment of the present disclosure.

FIGS. 4 and 5 are perspective views of antenna devices 1004 and 1005 according to still other embodiments of the present disclosure.

FIG. 6 is a perspective view of an antenna device 1006 according to still another embodiment of the present disclosure.

FIG. 7 is a perspective view of an antenna device 1007 according to yet another embodiment of the present disclosure.

FIGS. 8A-8C are perspective views and a top view of an antenna device 1008 according to an embodiment of the present disclosure.

FIGS. 9A-9C are perspective views and a top view of an antenna device 1009 according to another embodiment of the present disclosure.

FIGS. 10A-10C are perspective views and a top view of an antenna device 1010 according to another embodiment of the present disclosure.

FIGS. 11A-11C are perspective views and a top view of an antenna device 1011 according to another embodiment of the present disclosure.

FIGS. 12A and 12B are a top view and a side view of an antenna module 1200 according to an embodiment of the present disclosure.

FIG. 13 is a top view of an antenna module 1300 according to another embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

### DETAILED DESCRIPTION

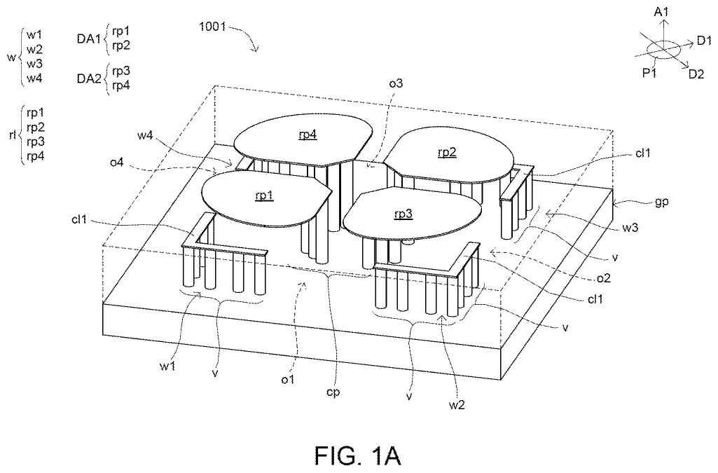

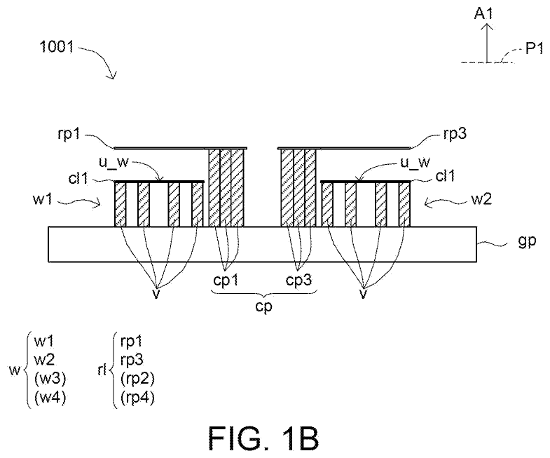

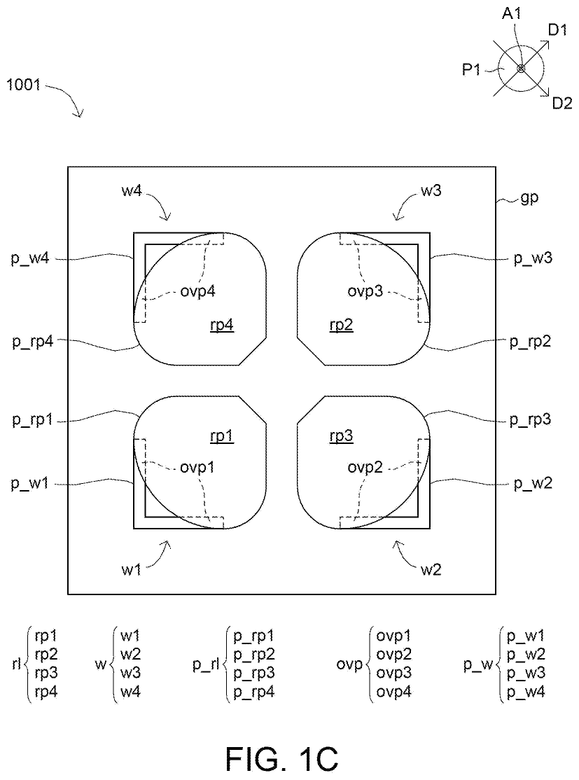

FIG. 1A is a perspective view of an antenna device 1001 according to an embodiment of the present disclosure. Referring to FIG. 1A, the antenna device 1001 includes a ground plate gp, a patterned radiating layer rl, a wall structure w and a supporting structure cp. The ground plate gp is arranged along a reference plane P1, i.e., the ground plate gp is substantially parallel with the reference plane P1. Furthermore, the patterned radiating layer rl is arranged above the ground plate gp and substantially parallel with the ground plate gp. Moreover, the wall structure w is formed above the ground plate gp or on an upper surface of the ground plate gp. That is, the wall structure w may be isolated from the ground plate gp with a gap, or the wall structure w may be connected with the upper surface of the ground plate gp. The wall structure w is substantially perpendicular to (i.e., orthogonal to) the ground plate gp and substantially parallel with a reference axis A1, where the reference axis A1 is substantially perpendicular to the reference plane P1. In addition, the supporting structure cp is formed on the upper surface of the ground plate gp, substantially perpendicular to the ground plate gp and substantially parallel with the reference axis A1. The patterned radiating layer rl may be coupled to the ground plate gp through the supporting structure cp.

In the embodiment of FIG. 1A, the patterned radiating layer rl includes a plurality of patterned portions, which are a radiating plate rp1, a radiating plate rp2, a radiating plate rp3 and a radiating plate rp4. The radiating plates rp1-rp4 are separated from one another. The supporting structure cp include a plurality of contact plugs extending along the reference axis A1. The contact plugs of the supporting structure cp correspondingly connect the radiating plates rp1-rp4 of the patterned radiating layer r to the ground plate gp.

The radiating plates rp1 and rp2 form a dipole antenna DA1 extending along a reference direction D1. The reference direction D1 is substantially parallel with the reference plane P1 and substantially perpendicular to the reference axis A1. The wall structure w forms a cavity between the patterned radiating layer rl and the ground plate gp, and the cavity may substantially surround the dipole antenna DA1. In one example, a projection of the cavity on the reference plane P1 may overlap a projection of the radiating plates rp1 and rp2. Furthermore, the size of the cavity may be equal to or smaller than the size of the antenna device 1001.

On the other hand, the radiating plates rp3 and rp4 form another dipole antenna DA2 extending along a reference direction D2. The reference direction D2 is substantially parallel with the reference plane P1 and substantially perpendicular to the reference direction D1 and the reference axis A1. The cavity formed by the wall structure w substantially surrounds the dipole antenna DA2, either. The dipole antenna DA1 (which is formed by the radiating plates rp1 and rp2) and the dipole antenna DA2 form a dual dipole antenna in the antenna device 1001.

In another antenna device of a comparative example (not shown), a cavity is formed by a traditional type of vias or formed by metal coating. The size of the cavity is greater than the size of this antenna device. Furthermore, an antenna module of this antenna device may have a greater size due to arrangement of the vias forming the cavity. Compared with the antenna device of the comparative example, the antenna device 1001 of the present disclosure may have a smaller size. Furthermore, the antenna device 1001 of the present disclosure may achieve a greater antenna gain, having a gain value of 1.2 dB-1.5 dB greater than that of the antenna device with traditional type of vias or metal coating.

The wall structure w includes a plurality of walls w1-w4. The walls w1-w4 are separated from one another by a plurality of openings o1-o4 respectively. For example, the walls w1 and w2 are separated by the opening o1, the walls w2 and w3 are separated by the opening o2, the walls w3 and w4 are separated by the opening o3, and the walls w4 and w1 are separated by the opening o4. The wall w1 is arranged at a location corresponding to the radiating plate rp1, the wall w3 is arranged at a location corresponding to the radiating plate rp2. Similarly, the wall 2 corresponds to the radiating plate rp3, and the wall 4 corresponds to the radiating plate rp4. Furthermore, each of the walls w1-w4 includes a plurality of conductive vias v which are formed above the ground plate gp or on the upper surface of the ground plate gp. That is, the conductive vias v may be isolated from the ground plate gp or connected with the upper surface of the ground plate gp. Each of the conductive vias v may take a form of a contact plug extending along the reference axis A1, which is substantially perpendicular to the ground plate gp. Moreover, the wall structure w may selectively include a conductive layer cl1. When the wall structure w includes the conductive layer cl1, such a conductive layer cl1 may be formed on the top of the conductive vias v. The conductive layer cl1 includes a plurality of patterned portions which are arranged on the walls w1, w2, w3 and w4 respectively.

In other examples, when the wall structure w is isolated from the ground plate gp with a gap (not shown), such that the conductive vias v are formed above the ground plate gp with a distance of the gap, the wall structure w may further include a conductive layer cl1b (not shown) formed on the bottom of the conductive vias v.

FIG. 1B is a side view of the antenna device 1001 of FIG. 1A. Referring to FIG. 1B, an upper surface u_w of the wall structure w is lower than the patterned radiating layer rl with respect to the reference axis A1. In one example, the conductive layer cl1, which is formed on the top of the conductive vias v, may serve as the upper surface u_w of the wall structure w. The conductive layer cl1 is lower than the patterned radiating layer rl with respect to the reference axis A1.

The supporting structure cp is arranged to support the patterned radiating layer rl. For example, some contact plugs cp3 of the supporting structure cp are arranged to support the radiating plate rp3 of the patterned radiating layer rl, and contact plugs cp3 connect the radiating plate rp3 to the ground plate gp. Likewise, other contact plugs cp1 of the supporting structure cp are arranged to support the radiating plate rp1 of the patterned radiating layer rl, and contact plugs cp1 connect the radiating plate rp1 to the ground plate gp. Furthermore, the supporting structure cp is surrounded by the wall structure w.

FIG. 1C is a top view of the antenna device 1001 of FIG. 1A. Referring to FIG. 1C, the walls w1, w2, w3 and w4 of the wall structure w have respective projections p_w1, p_w2, p_w3 and p_w4 on the reference plane P1. In one example, the projections p_w1, p_w2, p_w3 and p_w4 are projections of respective upper surfaces of the walls w1, w2, w3 and w4 on the reference plane P1. In another example, when a conductive layer cl1 is formed on the conductive vias v of the walls w1, w2, w3 and w4, the projections p_w1, p_w2, p_w3 and p_w4 are projection of the conductive layer cl1 on the reference plane P1. Furthermore, the radiating plates rp1, rp2, rp3 and rp4 of the patterned radiating layer rl have respective projections p_rp1, p_rp2, p_rp3 and p_rp4 on the reference plane P1.

The projection p_w1 of the wall w1 may overlap the projection p_rp1 of the radiating plate rp1 with an overlapping region ovp1. The overlapping region ovp1 has a ratio rat1 with respect to the projection p_w1 of the wall w1 in area, and the ratio rat1 is greater than 20%. Likewise, the projection p_w2 of the wall w2 may overlap the projection p_rp3 of the radiating plate rp3 with an overlapping region ovp2. The overlapping region ovp2 has the ratio rat1 (greater than 20%) with respect to the projection p_w2 of the wall w2 in area. Moreover, the projection p_w3 of the wall w3 may overlap the projection p_rp2 of the radiating plate rp2 with an overlapping region ovp3, and projection p_w4 of the wall w4 may overlap the projection p_rp4 of the radiating plate rp4 with an overlapping region ovp4. The overlapping regions ovp3 and ovp4 have the ratio rat1 with respect to the projections p_w3 and p_w4 respectively, where the ratio rat1 is greater than 20%.

In summary, the projections p_w1, p_w2, p_w3 and p_w4 of the walls w1, w2, w3 and w4 totally form a projection p_w of the wall structure w on the reference plane P1. Furthermore, the projections p_rp1, p_rp2, p_rp3 and p_rp4 of the radiating plates rp1, rp2, rp3 and rp4 totally form a projection p_rl of the patterned radiating layer rl. Moreover, the overlapping regions ovp1, ovp2, ovp3 and ovp4 between the projections p_w1, p_w2, p_w3 and p_w4 and the projections p_rp1, p_rp2, p_rp3 and p_rp4 totally form an overall overlapping region ovp. That is, the projection p_w of the wall structure w overlaps the projection p_rl of the patterned radiating layer rl with the overall overlapping region ovp. Accordingly, the overall overlapping region ovp has the ratio rat1, which is greater than 20%, with respect to the projection p_w of the wall structure w in area.

Since the projection p_w1 of the wall w1 overlaps the projection p_rp1 of the radiating plate rp1, equivalent capacitance between the wall w1 and the radiating plate rp1 may be enhanced. Likewise, the projections p_w2, p_w3 and p_w4 of the walls w2, w3 and w4 overlap the projections p_rp3, p_rp2 and p_rp4 of the radiating plates rp3, rp2 and rp4, hence equivalent capacitances between the walls w2, w3 and w4 and the radiating plates rp3, rp2 and rp4 may be enhanced.

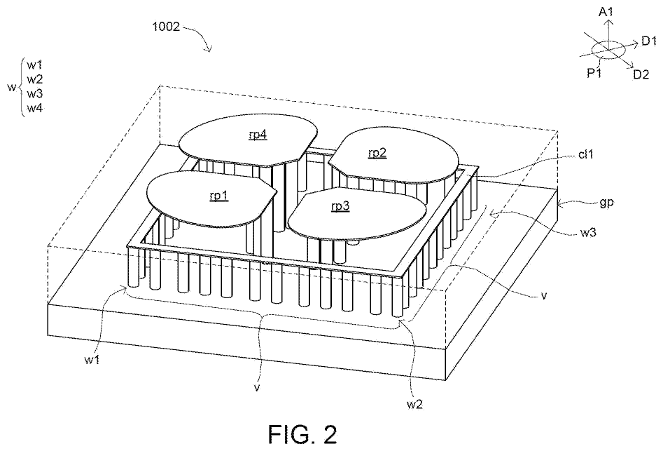

Next, referring to FIG. 2 which is a perspective view of an antenna device 1002 according to another embodiment of the present disclosure. The antenna device 1002 of FIG. 2 is similar to the antenna device 1001 of FIG. 1A except that, the antenna device 1002 of FIG. 2 has a wall structure w which takes a continuous form. Unlike the walls w1, w2, w3 and w4 of the antenna device 1001 of FIG. 1A which are separated from one another by openings o1-o4, in the antenna device 1002 of FIG. 2 the walls w1, w2, w3 and w4 are connected to one another, without any opening between them. The conductive vias v are uniformly or non-uniformly arranged under the conductive layer cl1.

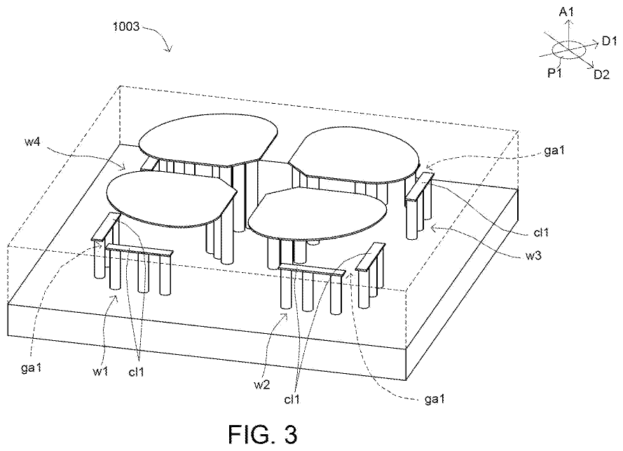

Next, referring to FIG. 3 which is a perspective view of an antenna device 1003 according to still another embodiment of the present disclosure. The antenna device 1003 of FIG. 3 is similar to the antenna device 1001 of FIG. 1A except that, the conductive layer cl1 of antenna device 1003 is not continuous. In one example, the discontinuities of the conductive layer cl1 are positioned at respective turning corners of the walls w1-w4, but not limited thereto. For example, the conductive layer cl1 has a gap gal (i.e., a discontinuity) at the turning corner of each of the walls w1-w4.

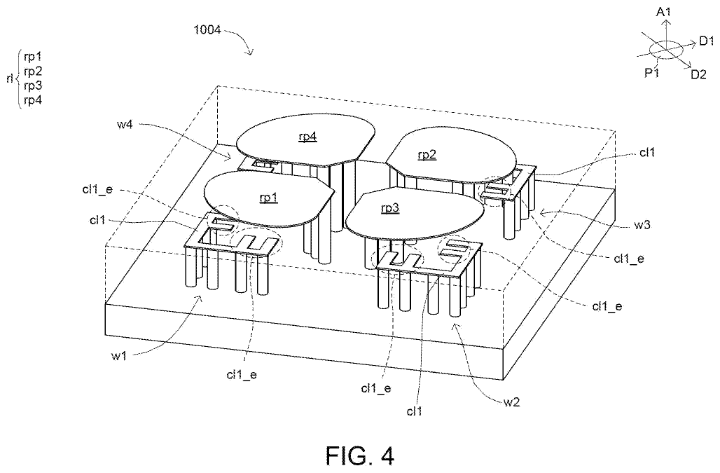

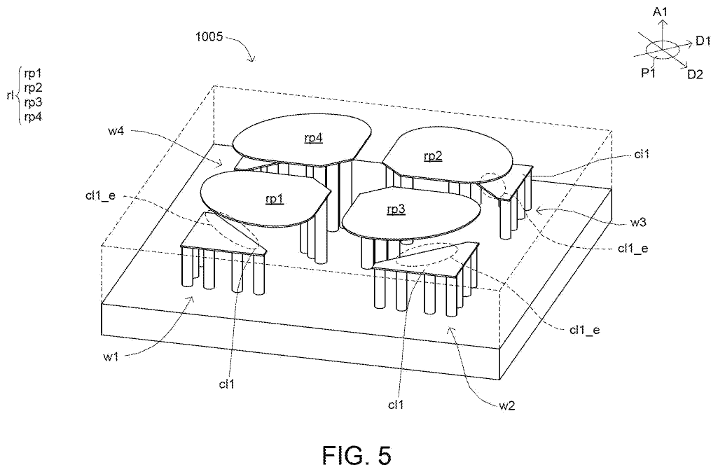

Next, referring to FIGS. 4 and 5 which are perspective views of antenna devices 1004 and 1005 according to still other embodiments of the present disclosure. The antenna devices 1004 and 1005 of FIGS. 4 and 5 are similar to the antenna device 1001 of FIG. 1A except that, the conductive layer cl1 of antenna devices 1004 and 1005 has an extending part cl1_e at each of the walls w1-w4. The extending part cl1_e has a patterned shape and extends under the patterned radiating layer rl. For example, the extending part cl1_e of conductive layer cl1 of antenna device 1004 of FIG. 4 has a fork shape. Furthermore, the extending part cl1_e of conductive layer cl1 of antenna device 1005 of FIG. 5 has a triangular shape. The extending part cl1_e may be used to adjust equivalent capacitance between the conductive layer cl1 and the radiating plates rp1-rp4.

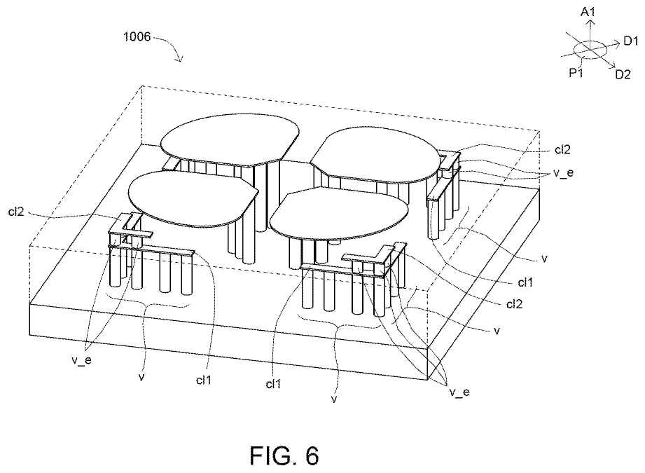

Next, referring to FIG. 6 which is a perspective view of an antenna device 1006 according to still another embodiment of the present disclosure. The antenna device 1006 of FIG. 6 is similar to the antenna device 1001 of FIG. 1A except that, the wall structure w of antenna device 1006 further includes a plurality of extending vias v_e and a conductive layer c12. The extending vias v_e are formed on the conductive layer cl1 and substantially parallel with the conductive vias v. Furthermore, the conductive layer c12 is formed on the extending vias v_e. In one example, the conductive layer c12 has a projection on the reference plane P1 which is less than the projection of the conductive layer cl1 in area.

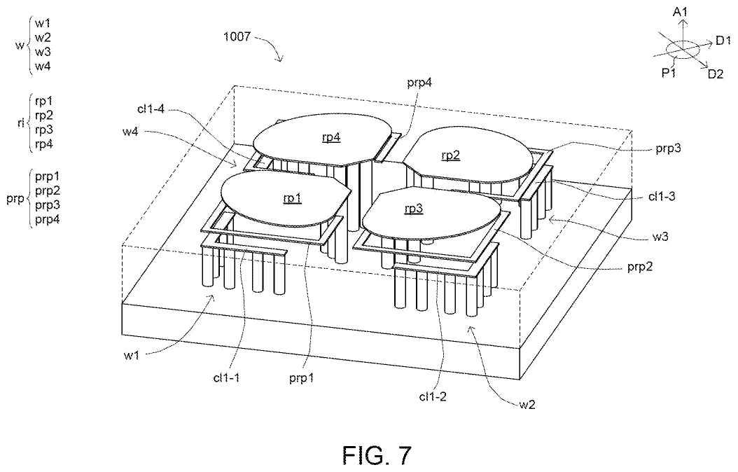

Next, referring to FIG. 7 which is a perspective view of an antenna device 1007 according to yet another embodiment of the present disclosure. The antenna device 1007 of FIG. 7 is similar to the antenna device 1001 of FIG. 1A except that, the antenna device 1007 further includes a parasitic layer prp which may be arranged with the same height as the patterned radiating layer rl. In other examples, the parasitic layer prp may be higher or lower than the patterned radiating layer rl. Furthermore, the parasitic layer prp may be arranged above the wall structure w.

The parasitic layer prp include parasitic plates prp1, prp2, prp3 and prp4 each having a form of rectangular frame. The parasitic plates prp1, prp2, prp3 and prp4 may be arranged above the walls w1, w2, w3 and w4 respectively. The parasitic plate prp1 is arranged at a position adjacent to the radiating plate rp1, and the parasitic plate prp1 may surround the radiating plate rp1. Furthermore, parasitic plate prp1 is arranged above a portion cl1-1 of the conductive layer cl.

Likewise, the parasitic plates prp2, prp3 and prp4 are arranged adjacent to the radiating plates rp3, rp2 and rp4 respectively, and surround the radiating plates rp3, rp2 and rp4. Furthermore, parasitic plates prp2, prp3 and prp4 are arranged above portions cl1-2, cl1-3 and cl1-4 of the conductive layer cl respectively.

In one example, a projection of the wall structure w overlaps projections of the parasitic plates prp1-prp4 on the reference plane P1. Furthermore, projections of the parasitic plates prp1-prp4 substantially surround projections of the radiating plates rp1-rp4.

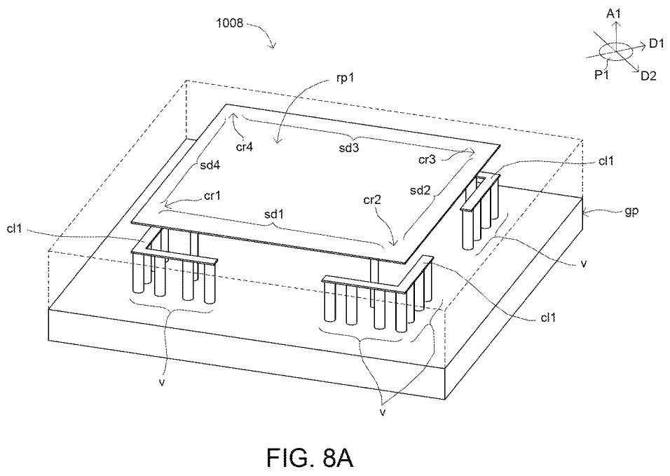

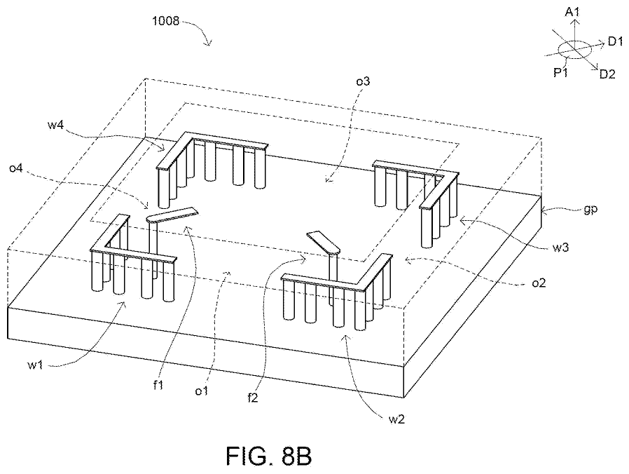

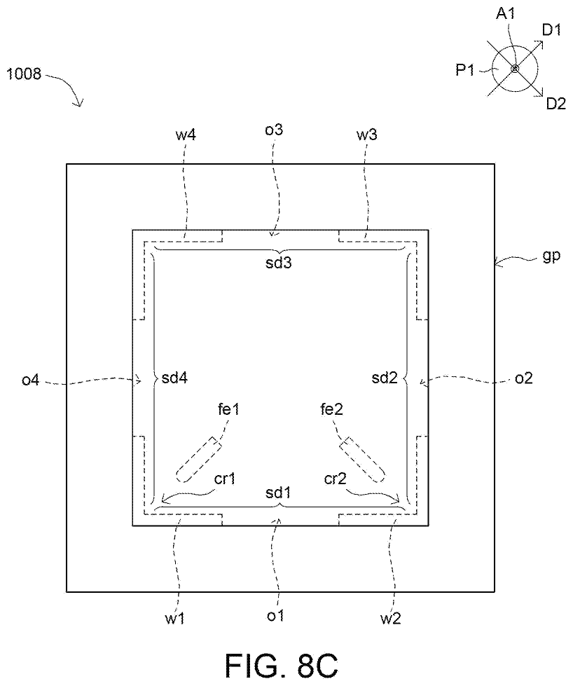

Next, referring to FIGS. 8A-8C which are perspective views and a top view of an antenna device 1008 according to an embodiment of the present disclosure. The antenna device 1008 of FIGS. 8A-8C is similar to the antenna device 1001 of FIG. 1A except that, the antenna device 1008 is a patch antenna with a single radiating plate rp1. Such a single radiating plate rp1 may take a rectangular form, and the radiating plate rp1 may have a plurality of corner regions cr1-cr4 and a plurality of side regions sd1-sd4.

Each of the side regions sd1-sd4 is arranged between corresponding two of the corner regions cr1-cr4. For example, the side region sd1 of the radiating plate rp1 is arranged between the corner regions cr1 and cr2, the side region sd2 is arranged between the corner regions cr2 and cr3, the side region sd3 is arranged between the corner regions cr3 and cr4, the side region sd4 is arranged between the corner regions cr1 and cr4. The corner regions cr1-cr4 of the radiating plate rp1 are arranged above the conductive layer cl1 of the walls w1-w4 of the wall structure w. On the reference plane P1, projections of walls w1-w4 of the wall structure w respectively overlap projections of the corner regions cr1-cr4.

Furthermore, the antenna device 1008 includes two feeders f1 and f2. The feeders f1 and f2 are arranged between the radiating plate rp1 and the ground plate gp. The feeder f1 includes a feeding element fe1 extending along the reference direction D1, and the feeder f2 includes a feeding element fe2 extending along a reversed direction of the reference direction D2. The feeding element fe1 is orthogonal to the feeding element fe2. The direction of the feeding element fe1 is directed to the corresponding wall w1, and the direction of the feeding element fe2 is directed to the corresponding wall w2. More particularly, direction of the feeding element fe1 is directed to the turning corner of the wall w1, and direction of the feeding element fe2 is directed to the turning corner of the wall w2. The feeding elements fe1 and fe2 may be conductively connected to the radiating plate rp1, or electromagnetically coupled to the radiating plate rp1. Antenna signals are provided to the radiating plate rp1 through the feeders f1 and f2. That is, the feeding element fe1 extends toward the corner region cr1 of the radiating plate rp1, and the feeding element fe2 extends toward the corner region cr2 of the radiating plate rp1.

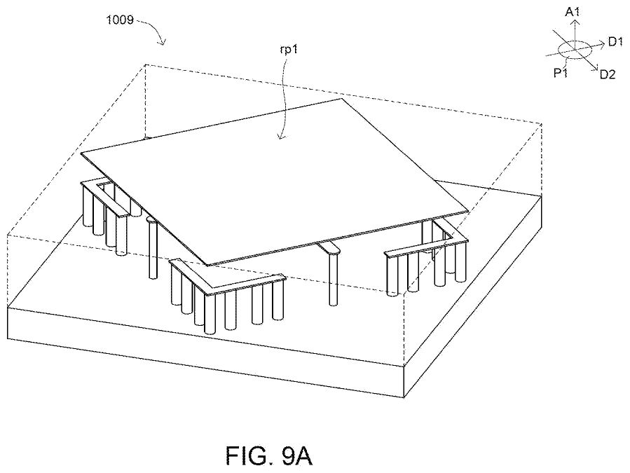

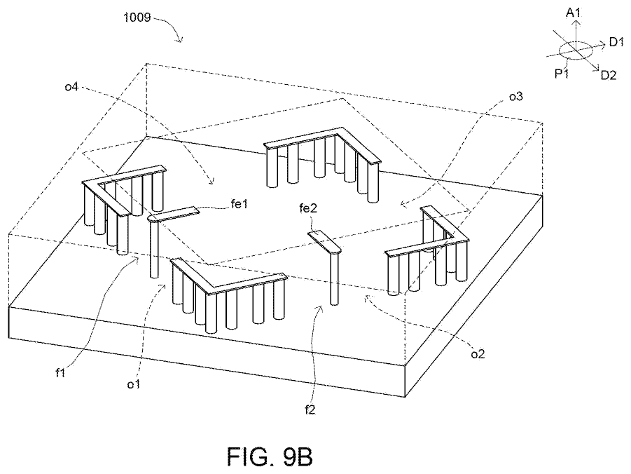

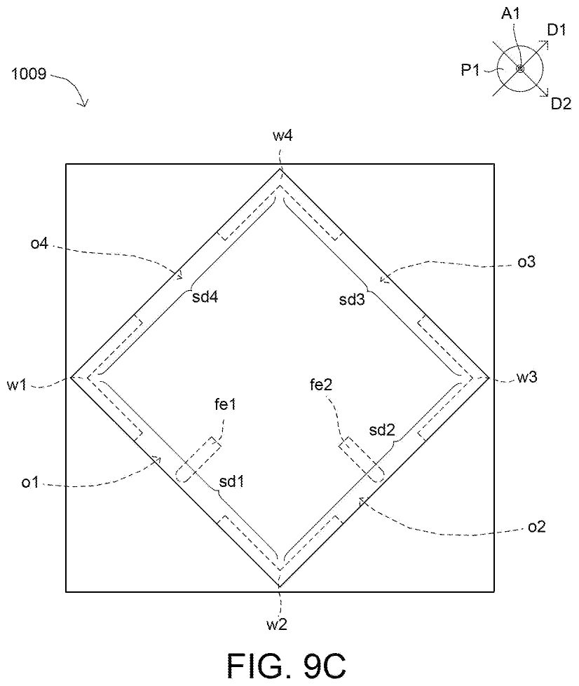

Next, referring to FIGS. 9A-9C which are perspective views and a top view of an antenna device 1009 according to another embodiment of the present disclosure. The antenna device 1009 of FIGS. 9A-9C is similar to the antenna device 1008 of FIGS. 8A-8C except that, directions of respective feeding elements fe1 and fe2 of the feeders f1 and f2 may not be directed to turning corners of the walls w1 or w2. Instead, directions of respective feeding elements fe1 and fe2 of the feeders f1 and f2 are directed to the openings o1 and o2 respectively. That is, the feeding element fe1 extends toward the side region sd1 of the radiating plate rp1, and the feeding element fe2 extends toward the side region sd2 of the radiating plate rp1.

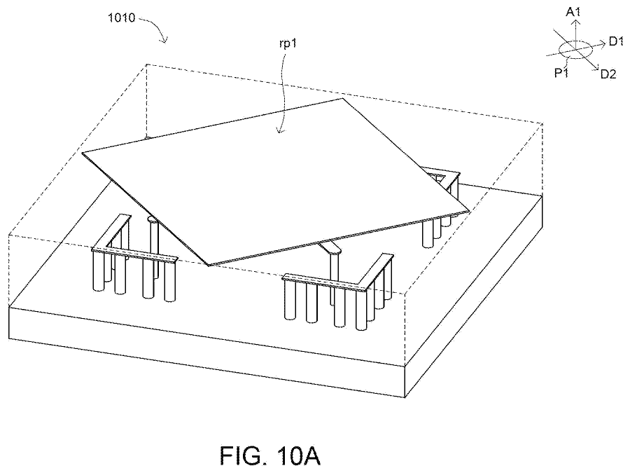

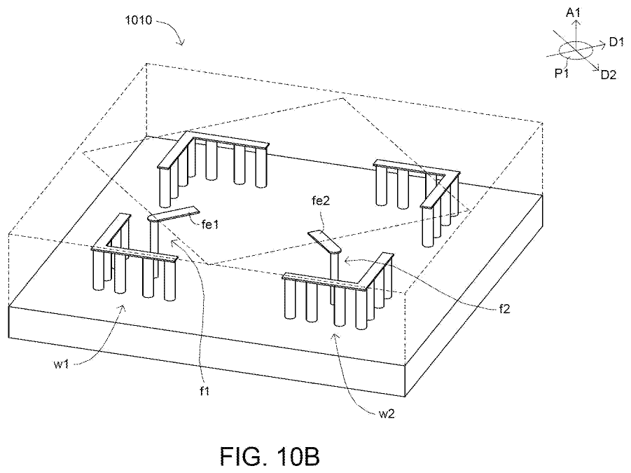

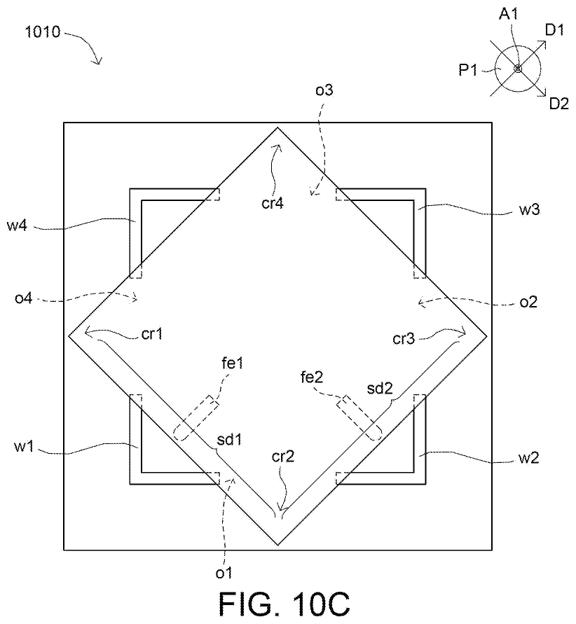

Next, referring to FIGS. 10A-10C which are perspective views and a top view of an antenna device 1010 according to another embodiment of the present disclosure. The antenna device 1010 of FIGS. 10A-10C is similar to the antenna device 1009 of FIGS. 9A-9C except that, directions of respective feeding elements fe1 and fe2 of the feeders f1 and f2 are directed to turning corners of the walls w1 and w2 respectively. Furthermore, the walls w1 and w3 are arranged with respect to the reference direction D1, and the walls w2 and w4 are arranged with respect to the reference direction D2. The walls w1 and w2 correspond to the side regions sd1 and sd2 respectively. That is, compared with the antenna device 1009 of FIGS. 9A-9C, the walls w1-w4 may be rotated by substantially 45 degrees.

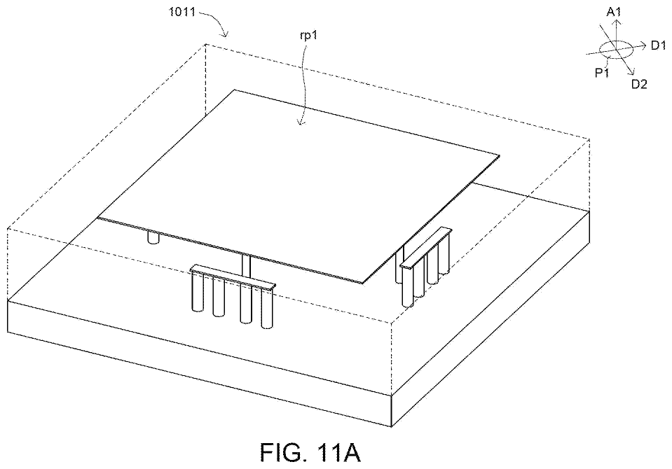

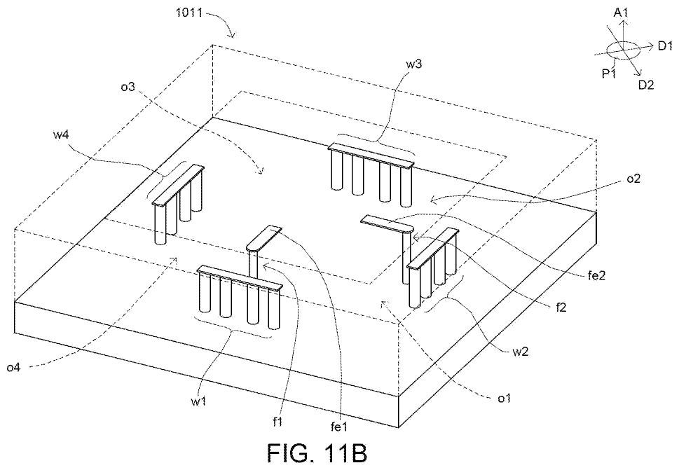

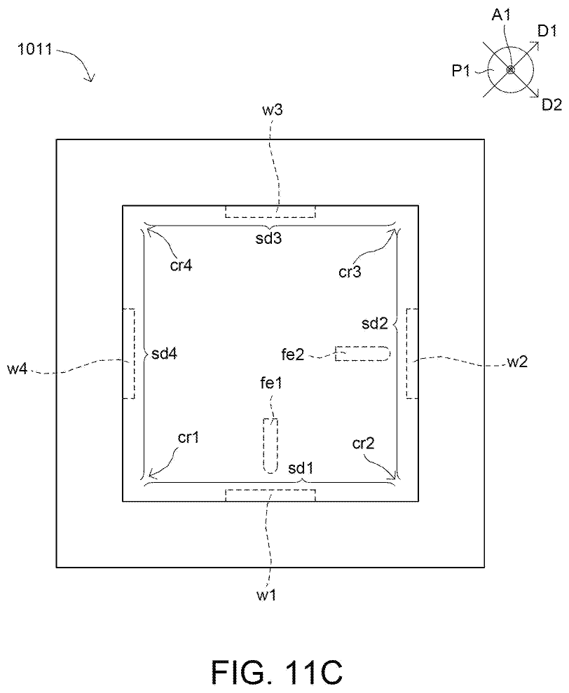

Next, referring to FIGS. 11A-11C which are perspective views and a top view of an antenna device 1011 according to another embodiment of the present disclosure. The antenna device 1011 of FIGS. 11A-11C is similar to the antenna device 1009 of FIGS. 9A-9C except that, each of the walls w1-w4 of the antenna device 1011 may take a straight form without any turning corner. Each of the walls w1-w4 has a projection of a straight form substantially parallel with corresponding one of the side regions sd1-sd4 of the radiating plate rp1 on the reference plane P1. Furthermore, the walls w1-w4 are separated from one another by openings o1-o4 respectively.

In one example, projections of the walls w1-w4 on the reference plane P1 may overlap projections of the side regions sd1-sd4 of the radiating plate rp1 respectively. Furthermore, the corner regions cr1, cr2, cr3 and cr4 of the radiating plate rp1 may correspond to the openings o4, o1, o2 and o3 respectively. Moreover, directions of respective feeding elements fe1 and fe2 of the feeders f1 and f2 are directed to the walls w1 and w2 and the side regions sd1 and sd2 of the radiating plate rp1 respectively.

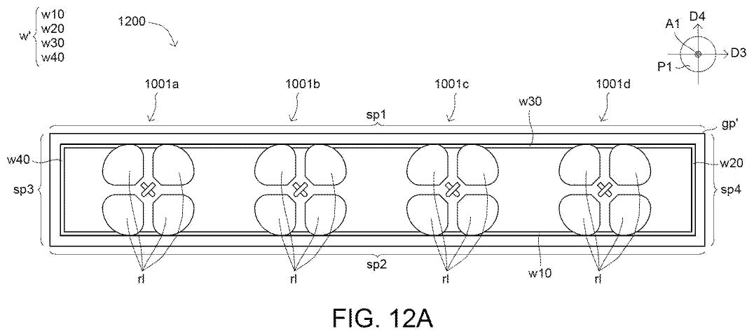

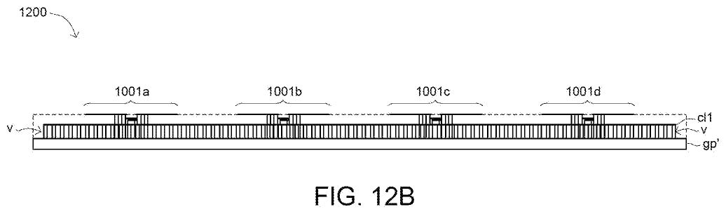

Next, referring to FIGS. 12A and 12B which are a top view and a side view of an antenna module 1200 according to an embodiment of the present disclosure. The antenna module 1200 includes a plurality of antenna devices 1001a, 1001b, 1001c and 1001d. Each of the antenna devices 1001a-1001d may be the same as the antenna device 1001 of FIG. 1A, which is, e.g., a dual dipole antenna.

The ground plate of the antenna device 1001a is connected with the ground plate of the adjacent antenna device 1001b. Likewise, the ground plate of the antenna device 1001b is connected with the ground plate of the antenna device 1001c, and then connected with the ground plate of the antenna device 1001d. The connected ground plates of antenna devices 1001a-1001d form a main ground plate gp′ for the antenna module 1200. The main ground plate gp′ has a plurality of side portions sp1, sp2, sp3 and sp4. The side portions sp1 and sp2 are arranged substantially parallel with a reference direction D3, and the antenna devices 1001a-1001d are arranged as a row along the reference direction D3. Furthermore, the side portions sp3 and sp4 are substantially parallel with a reference direction D4 which is orthogonal to the reference direction D3.

The wall structure of the antenna device 1001a is connected with the wall structure of the adjacent antenna device 1001b, and then connected with the wall structure of the antenna devices 1001c and 1001d. The connected wall structures of antenna devices 1001a-1001d form a main wall structure w′. The main wall structure w′ forms a main cavity substantially surrounding the patterned radiating layers rl of the antenna devices 1001a-1001d. The main wall structure w′ has a plurality of walls w10, w20, w30 and w40. The wall w10 is arranged near the side portion sp2 of the main ground plate gp′. Furthermore, other walls w20, w30 and w40 are arranged near the side portions sp4, sp1 and sp3 of the main ground plate gp′ respectively. In one example, the walls w10, w20, w30 and w40 may be formed on the upper surface of the side portions sp2, sp4, sp1 and sp3 of the main ground plate gp′ respectively. Moreover, the main wall structure w′ includes a plurality of conductive vias v uniformly or non-uniformly arranged on the upper surface of the side portions sp2, sp4, sp1 and sp3. In addition, a conductive layer cl1 is formed on the conductive vias v.

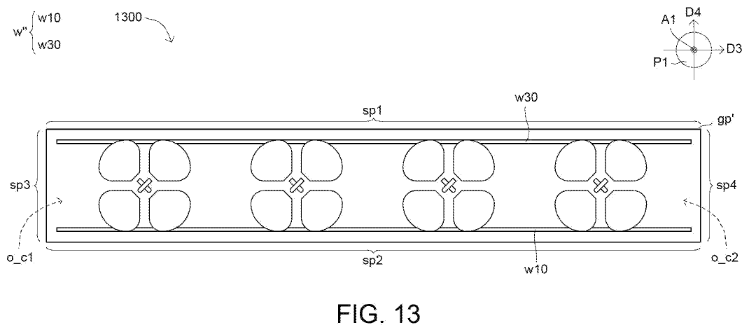

Next, referring to FIG. 13 which is a top view of an antenna module 1300 according to another embodiment of the present disclosure. The antenna module 1300 may be similar to the antenna module 1200 of FIGS. 12A and 12B except that, the antenna module 1300 has a main wall structure w″ with openings o_c1 and o_c2 (i.e., hence, the main cavity formed by the main wall structure w″ has openings o_c1 and o_c2). For example, the opening o_c1 is formed near the side portion sp3 of the main ground plate gp′, and the opening o_c2 is formed near the side portion sp4 of the main ground plate gp′.

Furthermore, the main wall structure w″ of the antenna module 1300 has two walls w10 and w30 which are formed on at least two of the side portions sp1-sp4 of the main ground plate gp′. For example, the wall w10 may be formed on the side portion sp2, and the wall w30 may be formed on the side portion sp1.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An antenna device, comprising:
a ground plate;
a patterned radiating layer, arranged above the ground plate; and
a wall structure, formed above the ground plate,
wherein, on a first reference plane substantially parallel with the ground plate, a projection of the wall structure overlaps a projection of the patterned radiating layer, and, with respect to a first reference axis substantially perpendicular to the ground plate, an upper surface of the wall structure is lower than the patterned radiating layer.

2. The antenna device according to claim 1, wherein the wall structure is formed on an upper surface of the ground plate.

3. The antenna device according to claim 1, wherein a projection of the upper surface of the wall structure overlaps the projection of the patterned radiating layer.

4. The antenna device according to claim 1, wherein, on the first reference plane, the projection of the wall structure overlaps the projection of the patterned radiating layer with an overlapping region, and the overlapping region has an first ratio greater than 20% with respect to the projection of the wall structure in area.

5. The antenna device according to claim 1, wherein the patterned radiating layer comprises:
a first radiating plate and a second radiating plate, forming a first dipole antenna extending along a first reference direction,
wherein the wall structure forms a cavity which substantially surrounds the first dipole antenna.

6. The antenna device according to claim 5, wherein the patterned radiating layer further comprises:
a third radiating plate and a fourth radiating plate, forming a second dipole antenna extending along a second reference direction substantially orthogonal to the first reference direction,
wherein the cavity formed by the wall structure substantially surrounds the second dipole antenna.

7. The antenna device according to claim 1, further comprising:
a plurality of parasitic plates, arranged above the wall structure,
wherein a projection of the wall structure overlaps projections of the parasitic plates on the first reference plane, and projections of the parasitic plates substantially surround the projection of the patterned radiating layer.

8. The antenna device according to claim 1, wherein the wall structure comprises:
a plurality of walls, each comprising:
a plurality of conductive vias, formed above the ground plate with a first gap or formed on the upper surface of the ground plate, wherein the conductive vias are substantially perpendicular to the ground plate,
wherein a first conductive layer, which is lower than the patterned radiating layer, is selectively formed on a top of the conductive vias, and a second conductive layer is selectively formed on a bottom of the conductive vias.

9. The antenna device according to claim 8, wherein when the first conductive layer is formed, the wall structure further comprises:
a plurality of extending vias, formed on the first conductive layer and substantially parallel with the conductive vias,
wherein a third conductive layer is selectively formed on the extending vias.

10. The antenna device according to claim 9, when the third conductive layer is formed, on the first reference plane, a projection of the third conductive layer is less than a projection of the first conductive layer in area.

11. The antenna device according to claim 8, wherein the walls are connected to one another.

12. The antenna device according to claim 8, wherein the walls are separated from one another by a plurality of openings.

13. The antenna device according to claim 12, wherein each of the walls has a turning corner, and the first conductive layer has a gap at the turning corner of each of the walls.

14. The antenna device according to claim 8, wherein the first conductive layer comprises:
an extending part at each of the walls,
wherein the extending part has a patterned shape and extends under the patterned radiating layer.

15. The antenna device according to claim 1, wherein the patterned radiating layer comprises:
a first radiating plate, having a plurality of corner regions and a plurality of side regions, wherein each of the side regions is arranged between corresponding two of the corner regions,
wherein, on the first reference plane, the projection of the wall structure overlaps projections of the corner regions or projections of the side regions.

16. The antenna device according to claim 15, wherein the wall structure comprises:
a plurality of walls, each comprising:
a plurality of conductive vias, formed on the upper surface of the ground plate and substantially perpendicular to the ground plate, wherein a first conductive layer is selectively formed on the conductive vias,
wherein the walls are separated from one another by a plurality of openings.

17. The antenna device according to claim 16, wherein each of the walls has a turning corner, and a projection of each of the walls overlaps a projection of a corresponding one of the corner regions on the first reference plane.

18. The antenna device according to claim 16, wherein a projection of each of the walls overlaps a projection of a corresponding one of the side regions on the first reference plane.

19. The antenna device according to claim 18, wherein each of the walls has a turning corner or has a straight projection substantially parallel with the corresponding one of the side regions on the first reference plane.

20. The antenna device according to claim 15, further comprising:
a first feeder and a second feeder, arranged between the first radiating plate and the ground plate,
wherein the first feeder comprises a first feeding element extending along a first reference direction, and the second feeder comprises a second feeding element extending along a second reference direction substantially orthogonal to the first reference direction.

21. The antenna device according to claim 20, wherein the first reference direction of the first feeding element and the second reference direction of the second feeding element are directed to corresponding two of the walls or corresponding two of the openings.

22. The antenna device according to claim 20, wherein the first reference direction of the first feeding element and the second reference direction of the second feeding element are directed to corresponding two of the corner regions or corresponding two of the side regions.

23. An antenna module, comprising:
a plurality of antenna devices of claim 1,
wherein the wall structure of one of the antenna devices is connected with the wall structure of an adjacent one of the antenna devices, and the wall structures of all of the antenna devices form a main cavity which substantially surrounds the projections of the patterned radiating layers of all of the antenna devices.

24. The antenna module according to claim 23, wherein the ground plate of one of the antenna devices is connected with the ground plate of an adjacent one of the antenna devices, and the ground plates of all of the antenna devices form a main ground plate which comprising:
a first side portion and a second side portion, substantially parallel with a third reference direction along which the antenna devices are arranged as a row; and
a third side portion and a fourth side portion, substantially parallel with a fourth reference direction orthogonal to the third reference direction,
wherein the wall structures of the antenna devices are formed on at least two of the first to the fourth side portions.

25. The antenna module according to claim 23, wherein the main cavity has openings on the third side portion and a fourth side portion.
